(19) United States
(12) Patent Application Publication
(10) Pub. No.: US 2014/0202212 A1
(43) Pub. Date: Jul. 24, 2014

(54) PRESS FORMING APPARATUS, PRESS FORMING METHOD, AND MOUNTING PLATE FOR PRESS FORMING

(71) Applicant: ASAHI GLASS COMPANY, LIMITED, Tokyo (JP)

(72) Inventors: Koki MORIYA, Tokyo (JP); Tomoharu HAYASHI, Tokyo (JP); Kohei HORIUCHI, Tokyo (JP); Keisuke YOSHIKUNI, Tokyo (JP)

(73) Assignee: ASAHI GLASS COMPANY, LIMITED, Tokyo (JP)

(21) Appl. No.: 14/222,773

(22) Filed: Mar. 24, 2014

Related U.S. Application Data
(63) Continuation of application No. PCT/JP2012/074007, filed on Sep. 20, 2012.

(30) Foreign Application Priority Data
Sep. 28, 2011 (JP) 2011-212486

(51) Int. Cl. C03B 11/12

(52) U.S. Cl. CPC C03B 11/122
USPC 65/106; 65/319; 65/374.13

(57) ABSTRACT

A press forming apparatus includes a mounting plate, a heating mechanism, and a die. The mounting plate supports a glass material on an upper surface of the mounting plate. The heating mechanism heats the glass material on the mounting plate to a temperature which allows press formation of the glass material. The die is provided to face the upper surface of the mounting plate and press forms the glass material heated by the heating mechanism between the die and the mounting plate.

### CROSS-REFERENCE TO RELATED APPLICATIONS

This application is a continuation of prior International Application No. PCT/JP2012/074007 filed on Sep. 20, 2012, which is based upon and claims the benefit of priority from Japanese Patent Application No. 2011-212486 filed on Sep. 28, 2011; the entire contents of all of which are incorporated herein by reference.

### BACKGROUND OF THE INVENTION

1. Field of the Invention

The present invention relates to a press forming apparatus, a press forming method, and a mounting plate for press forming.

2. Discussion of the Background

For forming a glass, various methods have hitherto been developed. Among others, as a method suitable for mass production, there is one heating a glass to a desired temperature and pressing this heated glass with a die (for example, see Japanese Patent Application Publication No. 2005-1919). In the method, after a plate glass is heated to a predetermined temperature, this heated plate glass is conveyed to a press mechanism by conveying rollers and then press formed.

### SUMMARY OF THE INVENTION

According to one aspect of the present invention, a press forming apparatus includes a mounting plate, a heating mechanism, and a die. The mounting plate supports a glass material on an upper surface of the mounting plate. The heating mechanism heats the glass material on the mounting plate to a temperature which allows press formation of the glass material. The die is provided to face the upper surface of the mounting plate and press forms the glass material heated by the heating mechanism between the die and the mounting plate.

According to another aspect of the present invention, a press forming method includes mounting a glass material on a mounting plate. The glass material on the mounting plate is heated to a temperature which allows press formation of the glass material. The heated glass material is press formed between a die and the mounting plate.

According to further aspect of the present invention, a mounting plate for press forming is used when press forming a glass plate, and has a linear expansion coefficient of 12×10⁻⁶/K or less.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings.

FIG. 1 is a structural diagram of a press forming apparatus according to an embodiment of the present invention.

FIG. 2A is a structural diagram of a conveying mechanism according to the embodiment. FIG. 2B is a cross-sectional view taken along a line X-X in FIG. 2A.

FIGS. 3A and 3B are diagrams illustrating a heating surface of a heating mechanism according to the embodiment.

FIG. 4 is a structural diagram of a press mechanism according to the embodiment.

FIG. 5 is a structural diagram of a press forming apparatus according to another embodiment of the present invention.

### DESCRIPTION OF THE EMBODIMENT

The embodiments will now be described with reference to the accompanying drawings, wherein like reference numerals designate corresponding or identical elements throughout the various drawings.

### Embodiment

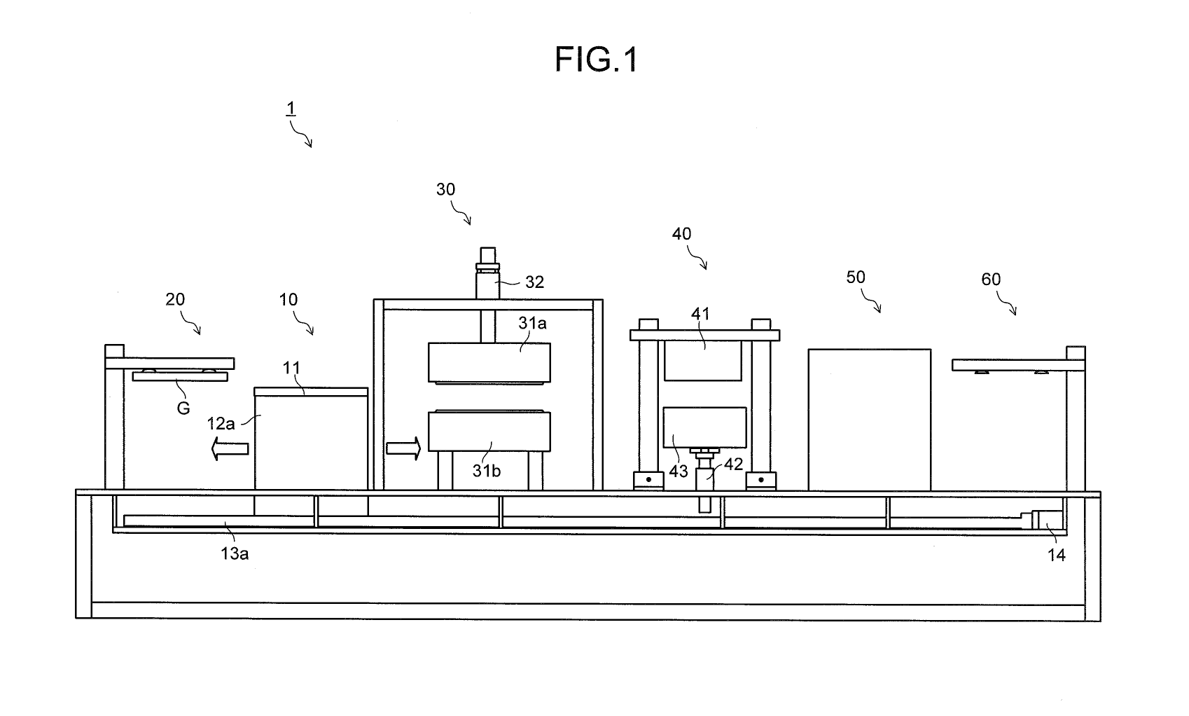

FIG. 1 is a structural diagram of a press forming apparatus 1 according to an embodiment. The press forming apparatus 1 has a conveying mechanism 10, a mounting mechanism 20 in a mounting station, a heating mechanism 30 in a heating station, a press mechanism 40 in a pressing station, a slow cooling mechanism 50 in a cooling station, and a removal mechanism 60 in a removing station.

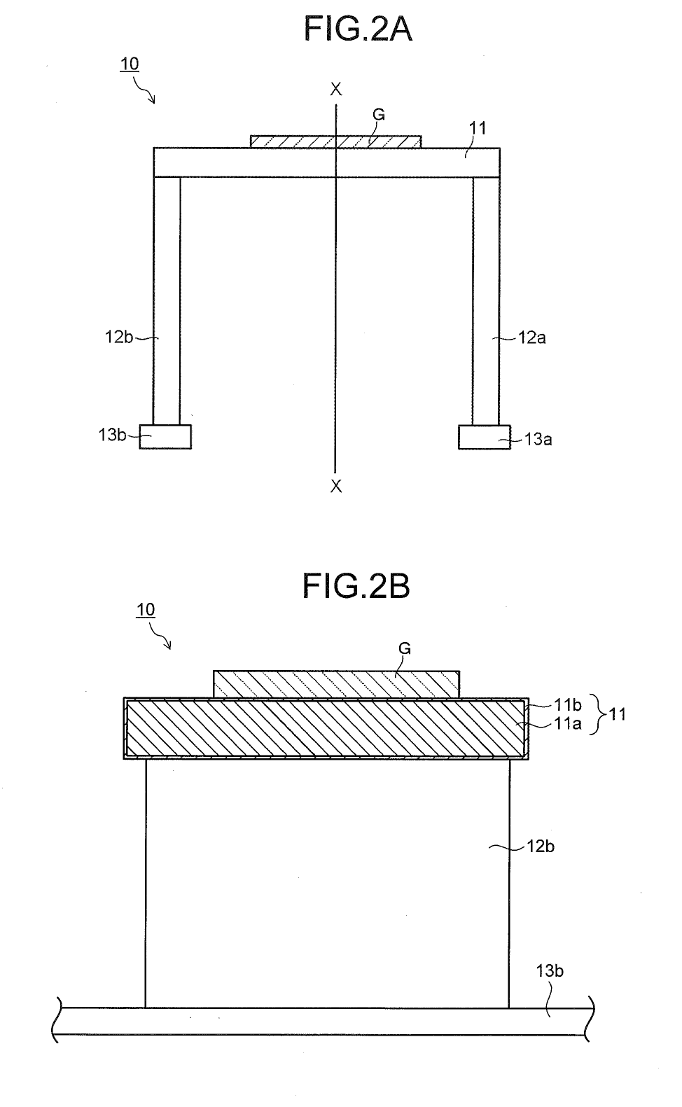

FIGS. 2A and 2B are structural diagrams of the conveying mechanism 10. FIG. 2A is a front view of the conveying mechanism 10. FIG. 2B is a cross-sectional view taken along a line X-X in FIG. 2A. Note that in FIG. 2 an illustration of a driving unit 14 is omitted. A conveying plate 11 combines the role of a die (lower die) for press forming, and has a size (for example, 300 mm long and 600 mm wide) to an extent that a plurality of glass formed products can be obtained by one time of press formation.

The conveying mechanism 10 has a conveying plate (mounting plate) 11 for conveying a glass material G as a target of press forming, support members 12a, 12b supporting both ends of the conveying plate 11, and guide rails 13a, 13b and a driving unit 14 for driving the support members 12a, 12b between the mounting mechanism 20 and the removal mechanism 60. The driving unit 14 is, for example, a stepping motor.

Since the conveying plate 11 combines the role of a lower die of a die to be used when press forming, it is required to have friction resistance, heat resistance, strength, and the like. Further, it will be exposed to high temperatures under the atmosphere, and hence is preferred to have oxidation resistance. Moreover, a temperature difference occurs between an upper surface side and a lower surface side in the conveying plate 11, and it is preferred that no warping occur due to this temperature difference.

This is because, if warping occurs in the conveying plate 11, it is not possible to give even pressure to the glass material G as a press forming target in the press mechanism 40, and there is a concern that transferring becomes insufficient. Considering that the conveying plate 11 is increased in temperature to about 1200° C. upon press forming, it is preferred that a linear expansion coefficient of substances constituting the conveying plate 11 be 12×10⁻⁶/K or less, so as to prevent insufficient transferring due to warping of the conveying plate 11.

Examples of substances which excel in friction resistance, heat resistance, strength, and the like and have a linear expansion coefficient of 12×10⁻⁶/K or less include ones described in Table 1 below.

TABLE 1

| | | Linear expansion | |
|---|---|---|---|
| Substance | | coefficient [K⁻¹] | Temperature [° C.] |
| Tungsten carbide | WC | 5.0 × 10⁻⁶ | 300 |
| Silicon carbide | SiC | 4.5 × 10⁻⁶ | 400 |
| Silicon | Si | 4.4 × 10⁻⁶ | 1000 |
| Platinum | N | 10.8 × 10⁻⁶ | 1000 |
| Molybdenum | Mo | 6.7 × 10⁻⁶ | 1200 |
| Silicon nitride | Si₃N₄ | 2.6 × 10⁻⁶ | 400 |
| Alumina | Al₂O₃ | 7.7 × 10⁻⁶ | 800 |
| Boron nitride | BN | 2.6 × 10⁻⁶ | 1500 |
| Aluminum nitride | AlN | 5.0 × 10⁻⁶ | 1000 |
| Carbon | C | 4.3 × 10⁻⁶ | 1000 |

As described above, the conveying plate 11 has a certain size (area) for press forming a plurality of formed products at once. Further, a thickness is also needed for ensuring strength to withstand press formation. In this case, if the entire conveying plate 11 is made of an expensive substance, manufacturing costs of the conveying plate 11 become quite expensive.

Accordingly, in this embodiment, as described in FIG. 2B, a base material 11a (for example, graphite (C)) constituted of a relatively inexpensive substance is coated with a coating film 11b (for example, silicon carbide (SiC)) excelling in friction resistance, heat resistance, oxidation resistance, and release property, so as to form the conveying plate 11. Note that if the linear expansion coefficient of the coating film 11b is less than or equal to the linear expansion coefficient of the base material 11a, the base material 11a becomes larger than the coating film 11b when the glass material G is heated on the conveying plate 11. As a result, there is a concern that a crack or the like occurs in the coating film 11b formed on the surface. Thus, care should be taken so as not to allow the linear expansion coefficient of the substance constituting the coating film 11b to be less than or equal to the linear expansion coefficient of the substance constituting the base material 11a.

As combinations of substances which make the linear expansion coefficient of the coating film 11b be larger than the linear expansion coefficient of the base material 11a, for example, combinations described in Table 2 below are conceivable. Note that the combinations illustrated in Table 2 are examples, and any other combination may be used as long as it is a combination of substances which makes the linear expansion coefficient of the coating film 11b be larger than the linear expansion coefficient of the base material 11a.

TABLE 2

| Combination | Base material | | Coating | |
|---|---|---|---|---|
| 1 | Carbon | C | Silicon carbide | SiC |
| 2 | Carbon | C | Aluminum nitride | AlN |
| 3 | Carbon | C | Platinum | Pt |
| 4 | Silicon nitride | Si₃N₄ | Silicon carbide | SiC |
| 5 | Silicon nitride | Si₃N₄ | Aluminum nitride | AlN |
| 6 | Silicon nitride | Si₃N₄ | Platinum | Pt |
| 7 | Silicon carbide | SiC | Molybdenum | Mo |
| 8 | Aluminum nitride | AlN | Platinum | Pt |
| 9 | Silicon carbide | SiC | Aluminum nitride | AlN |

The mounting mechanism 20 mounts the glass material G onto a predetermined position of the conveying plate 11. Note that instead of having the mounting mechanism 20, a user or operator may mount the glass material G onto the conveying plate 11.

The heating mechanism 30 has an upper heating unit 31a and a lower heating unit 31b which are disposed to oppose each other, and a driving unit 32 which drives the upper heating unit 31a in a vertical direction. The driving unit 32 is, for example, an air cylinder, and drives the upper heating unit 31a in a vertical direction (up and down direction) according to the thickness of the glass material G mounted on the conveying plate 11.

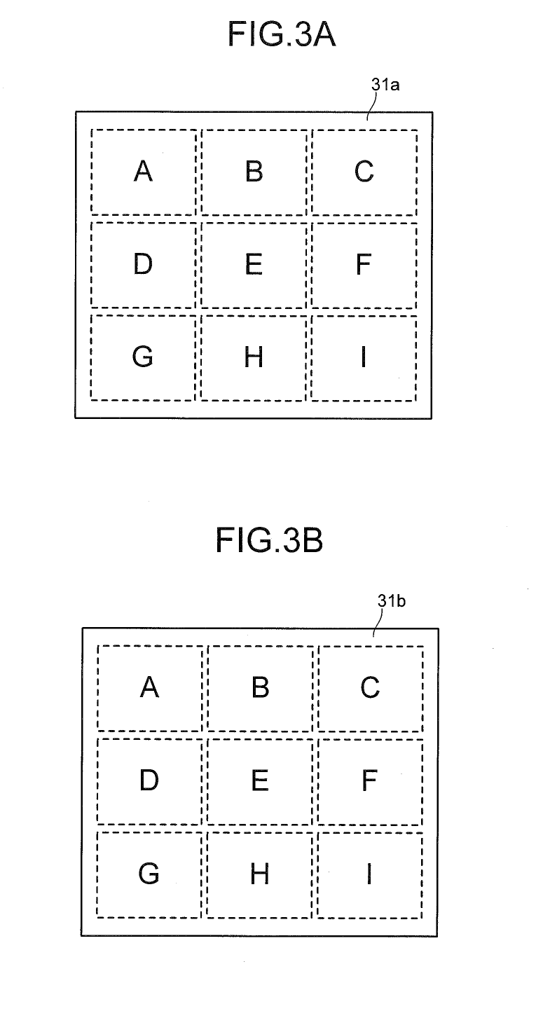

FIGS. 3A and 3B are diagrams illustrating heating surfaces of the upper heating unit 31a and the lower heating unit 31b. FIG. 3A is a diagram illustrating the heating surface of the upper heating unit 31a. The heating surface of the upper heating unit 31a has an area approximately equal to or larger than the conveying plate 11. The heating surface of the upper heating unit 31a is divided into nine areas A to I (each indicated by dashed lines). In each area A to I, a heating wire (not illustrated) for heating and a TC gauge (not illustrated) for measuring temperature are embedded, enabling independent temperature adjustment (hereinafter described as temperature adjustment) in every area A to I.

FIG. 3B is a diagram illustrating the heating surface (upper surface) of the lower heating unit 31b. The heating surface of the lower heating unit 31b also has an area approximately equal to or larger than the conveying plate 11. Further, the heating surface of the lower heating unit 31b is also divided into nine areas A to I. In each area A to I, a heating wire (not illustrated) for heating and a TC gauge (not illustrated) for measuring temperature are embedded, enabling independent temperature adjustment in every area A to I. The heating wire is, for example, a Nichrome wire (alloy of nickel and chrome).

Note that the number of divisions of the heating surface of the upper heating unit 31a and the lower heating unit 31b is not limited to nine. For example, the number of divided areas may be two. In this case, considering that there is large heat release in a peripheral edge of the conveying plate 11, preferably, it is divided into a peripheral area for heating the peripheral edge of the conveying plate 11 and an inside area for heating the inside of the conveying plate 11.

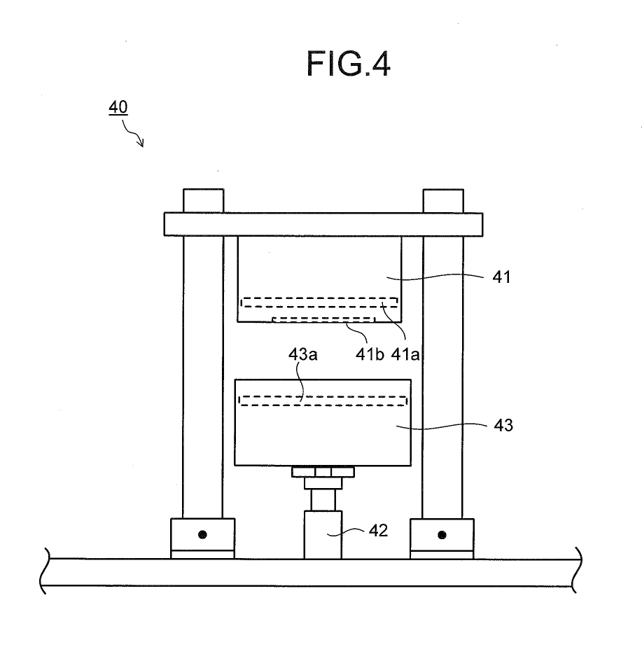

FIG. 4 is a structural diagram of the press mechanism 40. The press mechanism 40 has an upper die 41 for press forming the glass material G into a desired shape, a lifting unit 42 for driving the conveying plate 11 in a vertical direction (up and down direction), and a heat evening plate 43 which is provided on an upper part of the lifting unit 42 and abuts on a lower surface of the conveying plate 11 to push up the conveying plate 11. In the upper die 41, a plurality of cartridge heaters 41a are embedded, which are each capable of independently adjusting temperature. Further, in an abutting surface of the upper die 41 which abuts on the glass material G, a cavity 41b for press forming the glass material G into a desired shape is formed.

The lifting unit 42 is, for example, an air cylinder and drives the heat evening plate 43, which will be described later, in a vertical direction (up and down direction) by high-pressure air supplied from the outside. The heat evening plate 43 is constituted of a substance having high heat conductivity, for example, a stainless steel (SUS). In the heat evening plate 43, a plurality of cartridge heaters 43a are embedded, which are each capable of independently adjusting temperature. Note that the lifting unit 42 may be provided on the upper die 41 and structured to drive the upper die 41 in a vertical direction (up and down direction) to press form the glass material G.

Further, note that when there is a large temperature difference between the conveying plate 11 and the heat evening plate 43, a defect such as a crack may occur in the conveying plate 11 (particularly in the coating film 11b). For example, when the coating film 11b of the conveying plate 11 is a silicon carbide (SiC), if the temperature difference between the conveying plate 11 and the heat evening plate 43 exceeds 700° C., a crack or the like may occur in the coating film 11b due to thermal shock.

The slow cooling mechanism 50 slowly cools the glass material G press formed in a desired shape (for example, a cover glass of a mobile device such as a smart phone or tablet PC) to a desired temperature.

The removal mechanism 60 removes the glass material G in a desired shape slowly cooled by the slow cooling mechanism 50 from the conveying plate 11. Note that instead of having the removal mechanism 60, the user or operator may remove the glass material G in a desired shape from the conveying plate 11.

Next, operation of the press forming apparatus 1 will be described. The mounting mechanism 20 mounts the glass material G as the target of press forming on the conveying plate 11. The driving unit 14 of the conveying mechanism 10 conveys the conveying plate 11 to the position of the heating mechanism 30.

The driving unit 14 of the conveying mechanism 10 stops the conveying plate 11 between the upper heating unit 31a and the lower heating unit 31b for a certain time. The glass material G and the conveying plate 11 are heated to a desired temperature by the upper heating unit 31a and the lower heating unit 31b.

When the certain time passes, the driving unit 14 of the conveying mechanism 10 conveys the conveying plate 11 to the position of the press mechanism 40. When the conveying plate 11 is conveyed to the position of the press mechanism 40, the lifting unit 42 of the press mechanism 40 pushes up the heat evening plate 43. The heat evening plate 43 abuts on the lower surface of the conveying plate 11 to push up the conveying plate 11 to the upper die 41.

The glass material G on the conveying plate 11 is press formed into a shape of a cover glass C between the upper die 41 of the press mechanism 40 and the conveying plate 11. After the press forming, the lifting unit 42 lowers the conveying plate 11. The conveying plate 11 is mounted on the support members 12a, 12b.

The driving unit 14 of the conveying mechanism 10 conveys the conveying plate 11 to the position of the slow cooling mechanism 50. The driving unit 14 of the conveying mechanism 10 stops the conveying plate 11 in the slow cooling mechanism 50 for a certain time. The slow cooling mechanism 50 slowly cools the glass material G press formed in a desired shape to a desired temperature.

When the certain time passes, the driving unit 14 of the conveying mechanism 10 conveys the conveying plate 11 to the position of the removal mechanism 60. The removal mechanism 60 removes the glass material G press formed in a desired shape from the conveying plate 11.

As described above, the press forming apparatus 1 according to the embodiment uses the conveying plate 11 for conveying the glass material G and press forms the heated glass material G between the conveying plate 11 and the upper die 41. Accordingly, even a glass having low viscosity (for example, glass having viscosity η (Pa·s) of 1×10⁴ or less) can be conveyed.

Note that it is said that an appropriate viscosity range (point of operation) for forming a glass is about 10² to 10⁶ (Pa·s), which is very low viscosity. A glass in this viscosity range has high fluidity, and thus it is impossible to convey the glass alone. In this embodiment, as described above, the conveying plate 11 is used for conveying the glass material G, and the heated glass material G is press formed between the conveying plate 11 and the upper die 41. Thus, even such a glass having low viscosity can be easily press formed.

Accordingly, while conveying the glass material G is difficult by using the conveying rollers, the press forming apparatus 1 according to this embodiment can convey a glass having low viscosity as described above, and hence is preferable for press forming a cover glass of a mobile device such as a smart phone or tablet PC.

Moreover, the glass material G after heating is kept warm by the conveying plate 11, and thus occurrence of defect during press formation due to temperature fluctuation can be suppressed.

Further, with the heating surfaces of the upper heating unit 31a and the lower heating unit 31b of the heating mechanism 30 being divided into a plurality of areas A to I, it is possible to adjust temperature independently in every areas A to I, allowing even heating of the glass material G and the conveying plate 11. Thus, occurrence of defect during press formation due to temperature fluctuation can be suppressed.

Further, since the press mechanism 40 is provided with the heat evening plate 43 which abuts on the lower surface of the conveying plate 11 to cool the conveying plate 11, the cooling time of the glass material G after press formation can be shortened.

### Another Embodiment

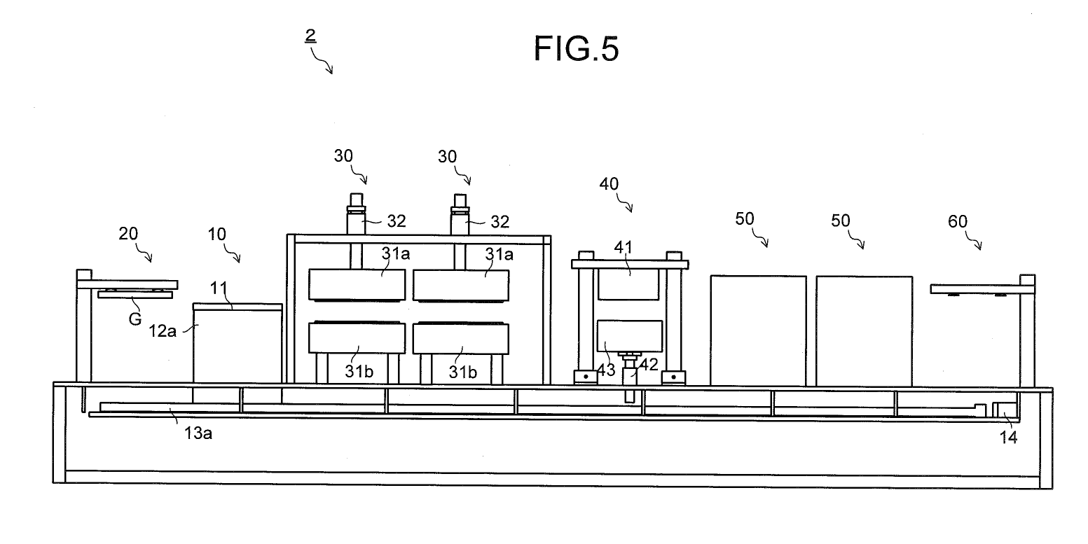

FIG. 5 is a structural diagram of a press forming apparatus 2 according to another embodiment. The press forming apparatus 1 according to the embodiment has one each of the heating mechanism 30 and the slow cooling mechanism 50, but a plurality of heating mechanisms 30 and a plurality of slow cooling mechanisms 50 may be provided (two each in FIG. 5). In press forming of a glass material, heating and cooling of the glass material take the most time. Thus, providing the plurality of heating mechanisms 30 and the plurality of slow cooling mechanisms 50 as in the press forming apparatus 2 allows increasing the number of times of press formation per unit time.

### EXAMPLES

Next, the present invention will be described in more detail by way of examples, but the invention is not limited to these examples.

The present inventors press formed a cover glass of a mobile device such as a smart phone or tablet PC from a glass material by using the press forming apparatus 1 described with reference to FIG. 1. Note that the press forming apparatus 1 used in this example does not have the mounting mechanism 20 and the removal mechanism 60, and mounting of the glass material and removal of the cover glass after press formation were performed by the user (present inventors). Hereinafter, the conditions of press forming in this example will be described.

(Glass Material G)

Values of thermal physical properties of the glass material G press formed in the example will be presented below. Note that the size of the press-formed glass material G is 50 mm long, 105 mm wide, and 2 mm thick.

Point of operation (Log₁₀η=2) 1000° C.

Softening point (Log₁₀η=7.6) 710° C.

Glass transition point 520° C.

(Conveying Plate 11)

On the surface of the base material 11a whose main component is graphite (C), the coating film 11b whose main component is a silicon carbide (SiC) was formed, and this was used as the conveying plate 11. Note that a main component here means that impurities may be contained to the extent that physical properties (particularly the linear expansion coefficient) of the main component do not change.

(Heating Mechanism 30)

The upper heating unit 31a and the lower heating unit 31b were each adjusted in temperature to 980° C. so as to heat the glass material G mounted on the conveying plate 11. In this case, the viscosity of the glass material was about 1×10⁶ (Pa·S).

(Press Mechanism 40)

The upper die 41 was adjusted in temperature to 530° C. and the heat evening plate 43 to 400° C., and then the glass material G mounted on the conveying plate 11 after heating was press formed. The glass material was press formed by force of 25 kN.

Note that in the cover glass after press formation, there were no blur or crack, and thus the glass having a desired shape was obtained. Thus, from the example, it was found that press forming can be performed on a glass having low viscosity without any problem.

According to the embodiments of the present invention, after a glass material is heated in a state of being mounted on a mounting plate, this heated glass material is press formed between a die and the mounting plate, thereby enabling press formation of a glass having low viscosity.

Specifically, since the surface of the conveyed plate glass is not in contact with the conveying rollers, even if viscosity of the conveyed glass is low, there is no concern that the glass is pulled into the conveying rollers, or flows out between the conveying rollers. Accordingly, a glass with low viscosity can be conveyed, and the type and temperature of the glass which can be conveyed are widely selected. Further, since the plate glass is not deprived of heat by the conveying rollers, the temperature distribution of the plate glass becomes even upon press forming, and there are little concerns of quality decrease of a glass after being formed, instability of glass quality, and the like.

The glass forming method of the embodiments of the present invention can efficiently form a glass in a state that the glass surface is smooth, and hence is preferable for forming glasses required to have designability, for example, glasses used for a cover glass of a mobile device such as a smart phone and a monitor such as an LCD.

Obviously, numerous modifications and variations of the present invention are possible in light of the above teachings. It is therefore to be understood that within the scope of the appended claims, the invention may be practiced otherwise than as specifically described herein.

What is claimed is:

1. A press forming apparatus comprising:
a mounting plate to support a glass material on an upper surface of the mounting plate;
a heating mechanism to heat the glass material on the mounting plate to a temperature which allows press formation of the glass material; and
a die provided to face the upper surface of the mounting plate and to press form the glass material heated by the heating mechanism between the die and the mounting plate.

2. The press forming apparatus according to claim 1,
wherein a linear expansion coefficient of the mounting plate is 12×10⁻⁶/K or less.

3. The press forming apparatus according to claim 1,
wherein a coating film is provided on an outer surface of the mounting plate.

4. The press forming apparatus according to claim 3,
wherein a linear expansion coefficient of the coating film is larger than a linear expansion coefficient of the mounting plate.

5. The press forming apparatus according to claim 3,
wherein a main component of the mounting plate is carbon, and a main component of the coating film is a silicon carbide.

6. The press forming apparatus according to claim 1, wherein the heating mechanism has a plurality of heating units, the mounting plate has a plurality of areas, each of the plurality of areas corresponding to each of the plurality of heating units and being heated by the each of the plurality of heating units independently.

7. The press forming apparatus according to claim 1, further comprising a lifting unit to push up the mounting plate to the die when the glass material is press formed between the die and the mounting plate.

8. The press forming apparatus according to claim 7, further comprising a heat evening plate provided on an upper part of the lifting unit to abut on a lower surface of the mounting plate and to cool the mounting plate when the glass material is press formed.

9. A press forming method comprising:
mounting a glass material on a mounting plate;
heating the glass material on the mounting plate to a temperature which allows press formation of the glass material; and
press forming the heated glass material between a die and the mounting plate.

10. The press forming method according to claim 9,
wherein the mounting plate has a plurality of areas, and each of the plurality of areas of the mounting plate is heated independently when the glass material is heated.

11. The press forming method according to claim 9,
wherein a lower surface of the mounting plate is supported while the heated glass material is press formed.

12. The press forming method according to claim 9, wherein the mounting plate is cooled while the heated glass material is press formed.

13. A mounting plate for press forming, which is used when press forming a glass material, and has a linear expansion coefficient of 12×10⁻⁶/K or less.

14. The mounting plate for press forming according to claim 13,
wherein a coating film is provided on an outer surface of the mounting plate.

15. The mounting plate for press forming according to claim 14,
wherein a linear expansion coefficient of the coating film is larger than the linear expansion coefficient of the mounting plate.

16. The mounting plate for press forming according to claim 14,
wherein a main component of the mounting plate is carbon, and a main component of the coating film is a silicon carbide.

17. The press forming apparatus according to claim 1,
wherein the heating mechanism is provided in a heating station, the die is provided in a pressing station, and the press forming apparatus further comprises a conveying mechanism to convey the mounting plate from the heating station to the pressing station.

18. The press forming method according to claim 9,
wherein the glass material is heated in a heating station, the glass material is press formed in a pressing station, and the press forming method further comprises conveying the glass material heated by the heating mechanism from the heating station to the pressing station.
